(19) United States
(12) Patent Application Publication
(10) Pub. No.: US 2018/0349831 A1
(43) Pub. Date: Dec. 6, 2018

(54) Method and System for Brokering Land Surveys

(71) Applicant: Geoffrey Harris, Miami, FL (US)

(72) Inventor: Geoffrey Harris, Miami, FL (US)

(21) Appl. No.: 15/933,358

(22) Filed: Mar. 22, 2018

Related U.S. Application Data
(60) Provisional application No. 62/475,043, filed on Mar. 22, 2017.

(51) Int. Cl. G06Q 10/06; G06Q 30/08; G06Q 30/02; B64C 39/02

(52) U.S. Cl. CPC G06Q 10/063118; G06Q 10/06314; G06Q 30/08; B64C 2201/123; G06Q 30/0206; B64C 39/024; G06Q 30/0205

(57) ABSTRACT

A method for providing on-demand service information for aerial surveys is provided. An application based software platform is created to form a medium for both customers and pilots to complete aerial survey requests. The application based software platform allows customers to post survey requests for pilots to view. If interested, pilots are able to compete for the survey requests. The interested pilots are then selected based upon the pilot criteria. The application based software platform creates a flight plan to conduct the survey. This flight plan is transmitted to the selected pilot and a drone, owned by the pilot, is dispatched to collect the raw data. Once collected, the raw data is received and processed by the computing system to create the survey. The survey is distributed to the customer, and the payment is distributed to the pilot. The survey is also stored in the database of surveys.

### CROSS-REFERENCE TO RELATED APPLICATIONS

This application claims the benefit of U.S. Provisional Application No. 62/475,043, filed Mar. 22, 2017, which is hereby incorporated by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The field of the invention is land surveys, and in particular to systems and methods for brokering land surveys to be made aerially.

### Description of the Related Art

Surveying, which is also known as land surveying, is the technique, profession, and science of determining the terrestrial or three-dimensional position of points and the distances and angles between them. A professional that conducts these surveys is called a land surveyor. These points are usually on the surface of the Earth, and they are often used to establish land maps and boundaries for ownership, locations like building corners or the surface location of subsurface features, or other purposes required by government or civil law, such as property sales.

To conduct surveys, surveyors use equipment like total stations, Global Positioning Satellite (GPS) receivers, three-dimensional scanners, radios, handheld tables, digital levels, drones, GIS, and surveying software. The planning and design of most construction projects require surveying. Surveying is also used in communications, mapping, and definition of legal boundaries of ownership.

Unmanned aircraft, which are also known as aerial drones or drones, have become popular and are owned and maintained by both hobbyists and professionals. Many types and brands of drones exist. Despite the variety, most drones share a set of components and controls that form a drone system. A drone system typically includes the drone itself, a portable computer, a remote control for sending flight instructions to the drone wirelessly, a camera on the drone for taking and recording photographs and/or videos during the drone's flight, and a GPS receiver on the drone for receiving and recording the location of the drone. The portable computer can be a smartphone, tablet computer, or laptop computer. The portable computer connects to the drone's remote control. The portable computer executes a computer program that sends a flight path or drone commands to the remote control. The remote control can be configured to receive flight-path data via an Application Programming Interface (API). The computer program transmits the flight path to the remote control according to the API. The remote control pilots the drone according to the flight path. The drone records photographs and/or videos with the camera during the flight. The drone records location from the GPS receiver as the drone flies. Once the drone completes the flight path, the pilot downloads the recorded photographs and/or videos and location data to the portable computer.

Many drown owners, particularly, hobbyists, operate their drones for enjoyment. A passion for flying drones leads may hobbyists to own and maintain drones with capabilities beyond the minimum requirements for conducting land surveys. Like in most hobbies, drone owners are always seeking money to maintain and operate their drones. A need of these hobbyists remains largely unfilled. The need is to obtain money to upgrade and maintain their drones while flying their drones.

Drones are used to generate land surveys. When generating land surveys with drones, a pilot takes a drone to a location to be surveyed. The pilot plots a flight plan for the drone. The pilot launches the drone and the drone follows the flight path. A camera on the drone records video and/or images as the drone flies the flight path. Geographical data, typically taken via a Global Positioning Satellite (GPS) receiver, is recorded and correlated with the recorded video and images. The images and data are transmitted from the drone to a surveyor. The surveyor uses a computer runs to execute a computer program that generates a land survey from the images and/or videos and data. The surveyor delivers the land survey to the customer.

Obtaining a surveyor to complete a project can be a drastic undertaking. Often, a real-estate purchaser or closing agent will be remote from the real estate itself. When the property is remote from the purchaser or closing agent and their local surveyors, the customer must search a local directory to find the surveyor and schedule a time to conduct the survey. This search and schedule method is unreliable and often results in large amounts of lost time on behalf of the consumer.

In the event that a successful search and scheduling does occur, the surveyor must still commute to the property to conduct the survey. The distance from the surveyor's office to site in need to be surveyed can be vast. This results in lost time on behalf of the surveyor.

Currently, there are no systems or methods available to provide a matching of surveyor location to site in need to be surveyed.

Accordingly, there exists a need for an on-demand land survey service that can match consumer to the surveyor in order to reduce wasted time and energy.

In industries unrelated to land surveys, sharing economy models have been used to enable ride sharing services such as those sold under the trademark UBER®. Ride sharing services run according to the following model. A software application (an “app”) runs on a driver's smartphone. Similarly, riders must have access to either a smartphone or ride sharing service's website. The ride sharing service can offer “upfront pricing”. That is, the rider enters a starting point and ending point, then the app offers a fare to the rider, and the rider can use the rider's app to accept the offer. In some cities, UBER® does not offer upfront pricing and instead calculates the price of a ride similar to a taximeter; the rider is charged based on the time and distance of the ride. UBER® also offers promotional rates on rides to/from certain areas at certain times. At the end of the ride, payment is made based on the rider's pre-selected preferences, which could be a credit card on file, cash. UBER® fares are based on a dynamic pricing model; the same route costs different amounts at different times as a result of factors such as the supply and demand for UBER® drivers at the time the ride is requested. When rides are in high demand in a certain area and there are not enough drivers in such area, UBER® fares increase to get more drivers to that area and to reduce demand for rides in that area. The rate quoted to the rider will reflect such dynamic pricing. Users of the app may rate drivers; in turn, drivers may rate users. A low rating might diminish the availability and convenience of the service to the user. If a driver rates a rider at three stars or below, the rider will never be paired with that driver again. UBER® can also deactivate or otherwise punish drivers that get low average ratings from riders. In some markets, where leasing arrangements for vehicles are available, the only requirement for driving for UBER®, other than appropriate age, health, car age and type, and ability to drive, is passing a background check. Both a smartphone, called a “device” by UBER®, and a vehicle may be leased. In many cities, vehicles used by UBER® drivers must pass annual safety inspections and must have an UBER® emblem posted in the lower right (passenger) side of the windshield. UBER® rolled out a new feature to some drivers that requires drivers to take selfies before accepting ride requests. The feature is called “Real-Time ID Check” and is meant to prevent fraud and protect drivers' accounts from being compromised.

### BRIEF SUMMARY OF THE INVENTION

An object of the invention is to provide a system and method for brokering land surveys between customers (i.e. consumers of land surveys) and aerial drone owners. The system and method direct on-demand aerial surveyors to sites in need of a land survey.

The system and method selects a surveyor from a set of available surveyors based on criteria. The criteria can include a location of the real-estate to be surveyed, a geographical area being serviced by each surveyor, a deadline when a survey is needed, technological requirements of the land survey, technology available to the surveyor.

The system and method can apply existing pricing strategies when brokering transactions between customers and surveyors.

An object of the invention is to provide a platform with a computing system with capabilities, provided by certain software and hardware, to optimize the service of completing aerial surveys. The computing system has the capabilities to receive customer data from application based software located on a mobile device operated by a customer. The customer data includes, but is not limited to, the geographic location of the customer, the geographic location of the site to be surveyed, and the payment for completing the survey. The system also receives the pilot data from application based software located on a mobile device operated by the pilot. The pilot data includes, but is not limited to, the geographic location of the pilot, pilot survey capabilities, and drone capabilities.

It is an object of the invention to match the customer survey requests with the ideal pilot in order to adequately and efficiently complete the survey. The survey request is transmitted through the application software on the mobile device from the customer's device to a computing system for processing. After being processed, the survey request is displayed for numerous pilots to view. The survey request may be provided to select pilots based upon the aforementioned pilot data in relation to the customer data. The number of pilots able to view the survey request may be further reduced by determining the availability of the pilot. The availability of the pilot may be determined by specified date, and specified time frames. The specified time frame may be determined in relation to the estimated time necessary to complete the survey request. Differing projects may take different amounts of time to complete. For instance, one project the size of three square miles located five miles from the pilot will take longer to complete than a project the size of one block located adjacent to the pilot. The computing system calculates the pilot's availability and schedules accordingly.

Once selected, the computing system dispatches the pilot to complete the survey request. The computing system tracks the progress of the survey, including an estimated time for completion. As the survey is being completed the customer may be notified of the estimated time of completion, and estimated time for receiving the survey. The estimated times may be calculated as a function of time in relation to the flight plan.

A further object of the invention is to provide an efficient method for conducting an aerial survey. In order to optimize the survey, a flight plan is provided. The flight plan is created after the customer transmits their survey request. The computing system calculates the optimal path to fly and collect the necessary data and creates a flight plan for the drone. This flight plan is transmitted to the drone of the selected pilot. When capable, the drone is able to be controlled by the computing system without the need of manual human intervention. This reduces the amount of error associated with human control, and ensures that the flight plan is adequately followed. When not capable of autopilot, the drone must be piloted by the selected pilot. Thus, the pilot must attempt to follow the flight plan with their best effort. As can be assumed, in situations without autopilot the drone is more susceptible to human error.

Both the manual and automatically controlled drones, when dispatched, collect raw data. This raw data is not in sufficient form to be transferred to the customer. Thus, the computing system must process the raw data in order to form the raw data into a usable survey for the customer. Once fully processed, the computing system transmits the completed survey to the customer.

It is an object of the invention to remove any unnecessary human intervention. In order to remove unnecessary human intervention, the computing system transforms the raw data into usable survey data for the customer. Instead of requiring manual work on behalf of surveyors to construct the raw data into a usable survey, the computing system receives and transforms the raw data into the usable survey.

In addition, the computing system controls the payment method for both the customers and the pilots. Instead of exchanging funds to one another, the customer makes payment to the computing system when making the request, and the pilot receives their payment once the service is completed. This removes any concern on behalf of the pilot for failure of getting paid once the work is completed.

It is an object of the invention to provide the customer with the most optimal survey possible. In order to achieve an optimal survey, adequate hardware must be utilized. This hardware includes the processors within the computing system, and the hardware within the drone itself. The drone hardware may be utilized to evaluate the available pilots. When utilizing the system, the pilot must provide the various capabilities that both they, and their drone have.

The necessary hardware that should be included in the drone are the camera, the global positioning system, and adequate battery capabilities. In the most efficient embodiment, the drone includes hardware that allows for autopilot functionality. With differing projects, the necessary hardware may vary. For example, projects requiring greater flying time will require drones with increased battery capabilities.

The autopilot functionality allows for the computing system to direct the drone according to the optimized flight plan. This removes any unnecessary deviation from the flight plan that may occur if drone were manually operated. While removing deviation from the flight plan, battery life is conserved and the elevation is adequately regulated. By adequately regulating the elevation, the drone will capture better data, thus translating to better survey once processed by the computing system.

It is an object of the current invention to provide aerial survey in accordance with the various laws and regulations in which the system is utilized. In order to abide by the laws and regulations the pilot criteria may further include the pilot's license to operate within the given area, and an adequate insurance plan to cover any unforeseen damages.

It is a further object of the current invention to provide for a bidding-selection forum for the completion of aerial surveys. In order to provide for the bidding-selection forum, the customer requesting the completion of the survey is able to set an asking price to complete the project. This asking price is then processed by the computing system and placed on the bid information for the selected pilots to view. The pilots, once shown the asking price, are able to bid down the price. The pilot with the lowest bid, that meets the necessary criteria, is given the opportunity to complete the survey.

By providing a bidding-selection forum, the customer is given the optimal price for the completion of their survey, and competition is encouraged. With the competition being encouraged, pilots are driven to better their pilot criteria in relation to the bid price. In order to increase the number of bids being given the pilots must provide a high level services for the lowest cost.

It is an object of the current invention to assure that the pilots completing the survey are fit to complete the survey. One way to ensure that the pilots are fit to complete the survey is by a rating system. After the completion of the survey, the customer is able to rate the pilot in accordance to how the survey was completed. The better the survey was completed, the higher the pilot's rating. If given a low rating the pilot will be encouraged to increase their rating in the subsequent survey. The display of the pilot rating may further be used in selecting the pilot.

Other features that are considered as characteristic for the invention are set forth in the appended claims.

Although the invention is illustrated and described herein as an on-demand method of providing aerial surveys, the invention should not be limited to the details shown in those embodiments because various modifications and structural changes may be made without departing from the spirit of the invention while remaining within the scope and range of equivalents of the claims.

### BRIEF DESCRIPTION OF THE SEVERAL VIEWS OF THE DRAWING

FIG. 1 is a flowchart illustrating a preferred embodiment of a method for brokering land survey according to the invention.

FIG. 2 is a schematic view of a system according to the invention.

### DETAILED DESCRIPTION OF THE INVENTION

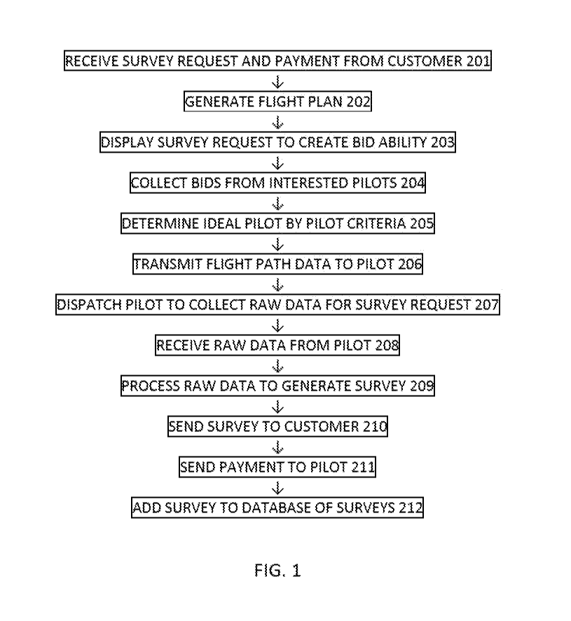

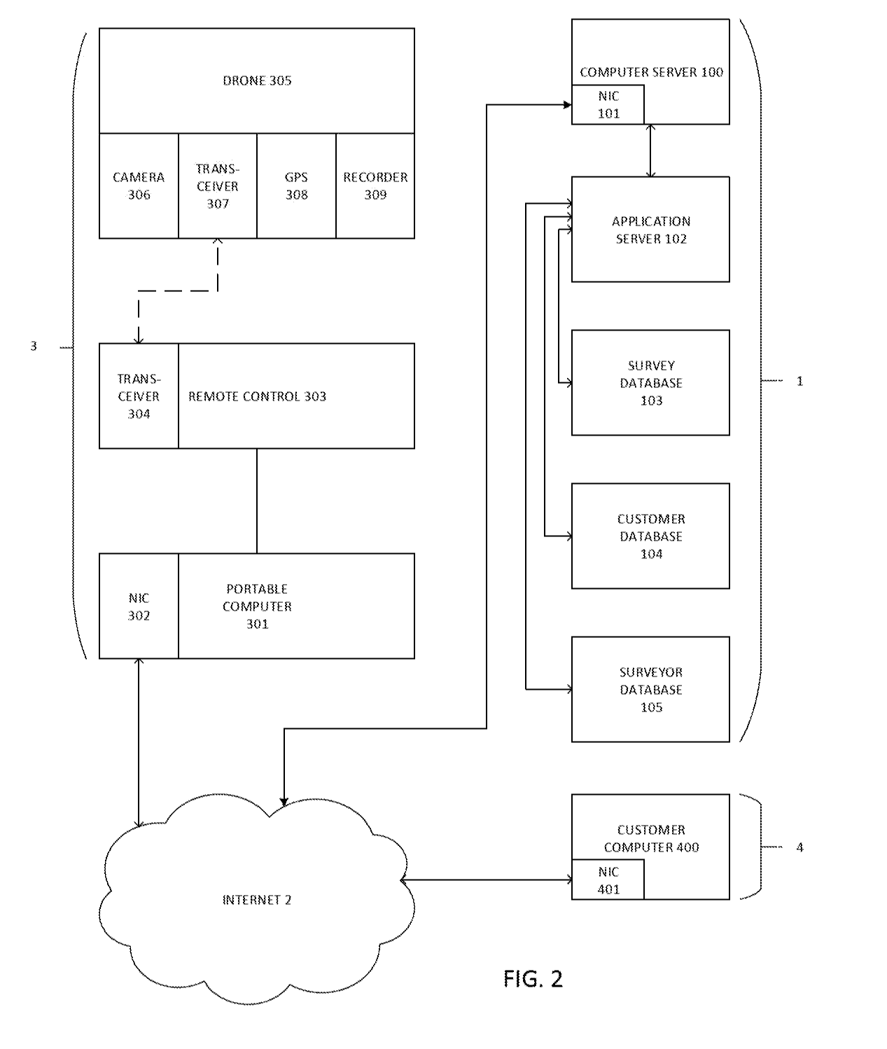

FIG. 1 shows a preferred embodiment of a method for brokering land surveys between customers and land surveyors. FIG. 2 shows a preferred embodiment of a system for performing the method. The method that is performed on the system shown in FIG. 2 described herein provides for an on-demand surveying service completed by a computing system, which selects pilots best suited to complete a survey request. Using this platform, customers are able to request surveys and surveys are completed in a more efficient manner, which increases the business of those pilots who compete on the platform. While the present invention is described with respect to what is presently considered to be the preferred aspects, it is to be understood that the invention as claimed is not limited to the disclosed aspects.

Furthermore, the invention is not limited to the particular methodology, materials, and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices and materials are now described.

FIG. 1 illustrates a method for brokering services between customers and land surveyors. For simplicity, FIG. 1 shows the interaction between one customer and the system. In practice, the system provides on-demand surveying services for a multiplicity of customers. In addition, the example system depicted shows multiple steps; however, some steps may be reordered or removed in their entirety without deviating from the invention.

FIG. 2 shows a preferred embodiment of the system. The preferred embodiment shows one customer and one surveyor. A preferred embodiment that is not shown includes multiple customers and surveyors. The system is a computer network with four network segments: a broker segment 1, a surveyor segment 3, a customer segment 4, and the Internet 2.

The broker segment 1 includes a computer server 100, an application server 102, a survey database 103, a customer database 104, and a surveyor database 105. The computer server 100 has a network interface controller (NIC) 101. The NIC 101 connects the computer server 100 to the Internet 2. The computer server 100 sends and receives data through the NIC 101 to and from the surveyor segment 3 and to and from the custom segment 4 via the Internet 2. The application server 102 receives and sends data to and from the computer server 100. The application server 102 receives and sends to and from the survey database 103, the customer database 104, and the surveyor database 105. The application server 102 processes survey requests from customers, generates flight plans from the survey requests, and stores the flight plans in the survey database 103. The application server 102 connects a surveyor to a customer based on the data stored in the customer database 104 and the surveyor database 105. Once a surveyor is selected, the computer server 100 transmits the flight plan from the survey database 103 to the portable computer 301. The web server 100 receives raw data from the portable computer 301 after the survey is completed. The application server 102 executes an application that converts the raw data to a survey. The application server 102 stores the survey in the survey database 103. The computer server 100 transmits the survey from the survey database 103 to the customer computer 400. The survey database 103 stores flight plans 107 and surveys 106. The customer database 104 stores survey requests 108, customer payment data 109, customer location 110, and survey-site location 111. The surveyor database 105 stores data describing the surveyor for example, surveyor contact information, surveyor location, surveyor service area, surveyor availability, and surveyor equipment.

The Internet 2 is a TCP/IP network.

The surveyor segment 3 includes a portable computer 301 with a NIC 302 to connect the portable computer 301 to the Internet 2. A remote control 303 receives a flight plan from the portable computer. The flight plan complies with an API of the remote control 303. The remote control 303 includes a wireless transceiver 304 that transmits flight plan data to a drone 305. The drone 305 has a camera 306, a wireless transceiver 307, a GPS receiver 308, and a data recorder 309. The drone 305 flies the flight plan. During the flight, the drone records video of the property being surveyed, and location data from the GPS receiver, and stores the video and location data on the recorder 309. After the flight, the recorder 309 is connected to the portable computer 301 and the video and location data are downloaded to the portable computer 301. As stated previously, the video and location data are transmitted from the portable computer 301 to the computer server 100 for processing.

In the single customer example provided, the method is initiated in step 201 by receiving a survey request 108 and customer payment data 109 from a customer. The survey request 108 includes a customer location 110 and a survey-site location 111. Preferred embodiments of survey-site locations 111 include an address, a legal description, longitude and latitude data, and GPS coordinates. In step 202, the survey request 108 is processed by the application server 102 to generate a flight plan 107. The flight plan 107 generated optimizes the rout best suited to complete the survey. Once the flight plan 107 is generated 202, the survey request 108 is sent from the computer server 100 to the portable computer 301 of each surveyor, in step 203.

Bids 112 are sent from the portable computer 301 of each interested surveyor and received by the computer server 100 and then stored in the surveyor database 105 in step 204. The surveyors interest in the survey request 108 may stem from the survey-site location 111 of the survey request 108 in relation to the surveyor location 113, the amount of land to be surveyed, and the amount of payment to be received. The application server 102 then determines the ideal pilot by comparing the data stored in the surveyor database 105, in step 205. The application server 102, when selecting a surveyor, considers surveyor location 113, the capabilities of the surveyor, the capabilities of the drone 305 owned by the surveyor, and the surveyor price 114 necessary to hire the surveyor. After the application server 102 selects the surveyor, in step 206, the flight plan 107 is transmitted from the computer server 100 to the portable computer 301 of the selected surveyor. In step 207, the surveyor utilizes the portable computer 301 and remote control 303 to pilot the drone 305 through the flight plan 107 and to record the raw data for the survey request 108. The surveyor can select to follow the flight path 107 automatically or manually.

In step 208, the computer server 100 receives the raw data from the portable computer 301. In step 209, the application server 102 executes a computer application that generates a survey 106 from the raw data and stores the survey 106 in the survey database 103.

In step 210, the computer server 100 transmits the survey 106 to the customer computer 400.

In step 211, the application server 102 disperses payment to the surveyor according to the surveyor payment data stored in the surveyor database 105.

In step 212, the application server 102 stores the survey 106 in the survey database 103.

In summary, the system provides for an efficient way to both request and complete survey requests. By using the system, the customer is able to place their survey request on a platform for locating pilots, thus removing the need to manually search for pilots who conduct surveys. In addition, pilots are given a platform in order to locate work, thus increasing their productivity by reducing the need to go out and compete for jobs. In combination, the profession of completing aerial surveys is optimized.

What is claimed is:

1. A method for brokering a land survey between a customer and a surveyor, which comprises:
storing surveyor data describing the surveyor in a computer database;
receiving a survey request with a computer server, the survey request being transmitted from the customer to the computer server;
generating a survey price for the survey request with an application server connected to the computer server, the survey price including a surveyor price and a broker commission;
receiving consent from the customer on the survey price;
receiving consent from the surveyor on the surveyor price;
generating a flight plan for an aerial drone from the survey request using the application server;
sending the flight plan from the computer server to a portable computer of the surveyor;
receiving raw data collected by the aerial drone of the surveyor;
generating a survey from the raw data with an application running on the application server; and
sending the survey from the computer server to a customer computer.

2. A method for providing information for an on-demand service, the method being performed by a computing system, which comprises:
receiving, through the computing system, customer data from an application based software on a mobile device operated by a customer, wherein said customer data includes a geographic location of the customer;
transmitting, through the computing system, a survey request from said application based software on the mobile device of said customer to a remote server for processing, wherein said survey request is for an aerial survey service;
receiving, through the computing system, pilot data from an application based software on a mobile device operated by a pilot, wherein said pilot data includes a geographic location of the pilot;
determining, through the computing system, an ideal pilot from a plurality of pilots based on, at least in part, said geographic location of each pilot; and
dispatching, through the computing system, the ideal pilot to complete said survey request.

3. The method according to claim 2, which further comprises:
receiving, through the computing system, pilot data from an application based software on a mobile device operated by a pilot, wherein the pilot data includes an availability of the pilot; and
determining, through the computing system, an ideal pilot from a plurality of pilots based on, at least in part, said provided availability of the pilot.

4. The method according to claim 3, wherein said availability of the pilot is based upon a specified date.

5. The method according to claim 3, wherein said availability of the pilot is based upon a specified time.

6. The method according to claim 5, wherein said availability of the pilot based upon said specified time, is in relation to a specified estimated duration to complete said survey request.

7. The method according to claim 2, further comprising sending, through the computing system, a dispatch notification from said remote server through said application based software on said mobile device of the customer.

8. The method according to claim 2, which further comprises:
receiving, through the computing system, a completion notification from said application based software on said mobile device of the pilot; and
sending, through the computing system, said completion notification from said remote server to said application based software on said mobile device of the customer.

9. The method according to claim 2, which further comprises:
receiving, through the computing system, a survey data file from said application based software on said mobile device of the pilot; and
sending, through the computing system, said survey data file from said remote server to said application based software on said mobile device of the customer.

10. A method for providing information for an on-demand service, the method being performed by a computing system, comprising:
receiving, through the computing system, pilot data from a plurality of pilots from an application based software on a mobile device operated by each pilot, wherein said pilot data includes, at least a geographic location of the pilot;
receiving, through the computing system, customer data from an application based software on a mobile device operated by a customer, wherein said customer data includes a geographic location of the customer, geographic location of a survey site, and a payment;
generating, through the computing system, a flight plan based on a survey request, wherein said survey request if formed from at least said geographic location of the survey site;
transmitting, through the computing system, said survey request to said application based software on the mobile devices of the plurality of pilots to generate bids from at least one interested pilot;
receiving, through the computing system, bids from said application based software on the mobile devices of the interested pilots;
determining, through the computing system, an ideal pilot for completing said survey request, wherein said ideal pilot is determined based on pilot criteria;
transmitting, through the computing system, said flight plan based survey to the software based application on the mobile device of said ideal pilot;
dispatching, through the computing system, a drone operated by said ideal pilot, to collect raw data for survey request, wherein said drone includes a multiplicity of drone hardware;
receiving, through the computing system, said raw data from said drone;
processing, through the computing system, said raw data to generate survey;
transmitting, through the computing system, said survey to said application based software on the mobile device of said customer;
transmitting, through the computing system, said payment to said application based software on the mobile device of said ideal pilot; and
storing, through the computing system, said survey to a database of surveys.

11. The method according to claim 10, wherein said drone hardware includes at least a camera, global positioning system, and autopilot functionality.

12. The method according to claim 10, further comprising:
receiving, through the computing system, a rating from the customer, said rating being stored in said pilot criteria of said ideal pilot.

13. The method according to claim 10, wherein said computing system directs said drone automatically based upon said flight plan.

14. The method according to claim 10, wherein said drone is manually directed by said ideal pilot in accordance with said flight plan.

15. The method according to claim 10, wherein said pilot criteria includes at least one of: a camera quality of drone, a flight plan processor, a license to operate, an insurance plan, a payment request, an average of past ratings, and a geographic location.

16. A system for brokering land surveys between a customer and a surveyor, comprising:
a computer server being configured to receive a survey request from the customer, the survey request identifying land to be surveyed;
an application server being configured to execute an application to generate a flight plan for an aerial drone from the survey request, the flight plan providing a flight path for an aerial drone of the surveyor, the flight plan steering the aerial drone over the land in order to collect raw data;
said computer server being configured to transmit the flight plan to a portable computer of the surveyor;
said computer server being configured to receive the raw data;
said application server being configured to execute an application to generate a survey from the raw data; and
said computer server being configured to transmit the survey to the customer.
